(19) United States
(12) Patent Application Publication
(10) Pub. No.: US 2006/0268833 A1
(43) Pub. Date: Nov. 30, 2006

(54) Mobile to mobile and voice over internet protocol communication system and apparatus

(76) Inventor: Gill Yardley, Manti, UT (US)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(21) Appl. No.: 11/138,923

(22) Filed: May 26, 2005

(51) Int. Cl. H04L 12/66

(52) U.S. Cl. 370/352

(57) ABSTRACT

A communication system, method, and apparatus allowing a user to make and receive calls at a mobile calling device utilizing a voice over internet protocol to reduce or eliminate rate charges that would otherwise be incurred as a result of the call. A primary mobile device is utilized to make calls to a secondary mobile device utilizing a mobile-to-mobile calling plan or other reduced fee rate plan. The secondary mobile device is connected to an internet access device such as a mobile interface or a computer. The internet access device provides connectivity between the secondary mobile device and a voice over internet protocol. The system and apparatus are configured such that a user can make a call from the primary mobile device to the voice over internet protocol through the secondary mobile device.

### BACKGROUND OF THE INVENTION

1. The Field of the Invention

The present invention relates to a communication system and apparatus. In more particular, the present invention relates to a communication system and apparatus allowing a user to make and receive calls at a mobile calling device utilizing a voice over internet protocol and/or over a land line phone system.

2. The Relevant Technology

Traditionally users desiring to communicate with one another telephonically have been limited in their choice of communication systems that can be utilized for such telephonic communications. For example, a user desiring to contact another user utilizing traditional land line systems must make such calls through the service provider. Land line service providers typically include local telephone utilities, long distance carriers, or a combination of the above. Because users must use land line service providers, the rates for such calls are primarily dictated by stringent and otherwise fixed minute-to-minute or standard calling rates. For example, a user may have a utility rate plan allowing unlimited local calls but charging a fee for per minute for all long distance calls. As a result, the length of the call is heavily influenced by the particular per minute rate to which the call is subject and may be much shorter than the duration desired by the user.

The emergence and prevalence of mobile communication systems which support mobile devices such as cellular phones, PDAs, and the like, have allowed users a greater degree of choice and flexibility in making telephone calls to a destination number. Not only do users have a greater degree of flexibility in calling from various locations without being restricted to the use of a land line, but the users are able to select from various carrier's calling plans and rates. Competition in the mobile communication industry has resulted in significantly reduced rates for calls. As the cost of mobile calling plans has decreased, some users have canceled their traditional land line service and instead use their mobile calling plan exclusively.

One development which has facilitated the popularity of mobile calling plans are mobile-to-mobile calling plans or family calling plans. Such plans will often allow a user to call one or more other users on the same contract for no fee or for a small monthly fixed rate. Because a typical user will make the bulk of calls to a single other user such as the user's spouse, co-worker, or friend, such mobile-to-mobile calling plans significantly reduce the monthly billing charges incurred by an individual user.

Another technology that has facilitated greater competition and reduced calling rates for telephonic communications is voice over internet protocols. A voice over internet protocol allows a user to bypass traditional long distance rate calling plans utilizing Internet connections. Voice over internet protocols are utilized in connection with a user's computer or other Internet access device. The user connects with the voice over internet protocol, inputs a destination number, enabling the user to talk through the user's computer over the dialup connection for a small monthly charge or, in some circumstances, for no charge at all. This provides the user greater flexibility in determining the number of long distance calls to make, the duration of such calls, and even the destination of the call. While voice over internet protocols have become more widely utilized, they continue to be tied to traditional land line technologies. As a result, a user is forced to make such calls from the user's home or work to realize cost savings for such calls.

The emergence of PDAs, which combine mobile phones with internet connectivity has opened the door for voice over internet protocols in connection with mobile calling devices. However, the duration of connectivity on a mobile device is still subject to minute-to-minute charges which are incurred when making use of the mobile phone or other mobile device. As a result, the user may be able to connect to a voice over internet protocol and avoid long distance charges which may be incurred when calling long distance or international numbers. However, the duration of the call or other connectivity still results in rate charges on the mobile calling plan.

### BRIEF SUMMARY OF THE INVENTION

The present invention relates to a communication system allowing a user to make and receive calls at a mobile calling device utilizing a voice over internet protocol to reduce or eliminate rate charges that would otherwise be incurred as a result of the call. A primary mobile device and a secondary mobile device which are operably connected utilizing a mobile-to-mobile calling plan or other reduced fee rate plan is provided according to one embodiment of the present invention. The primary mobile device is carried by and utilized by the user for telephonic communications. The secondary mobile device is connected to an internet access device such as a specialized mobile interface or a computer. The internet access device provides connectivity between the secondary mobile device and a voice over internet protocol. The system and apparatus are configured such that a user can make a call from the primary mobile device to the voice over internet protocol through the secondary mobile device.

Because the call from the primary mobile device to the secondary mobile device is on the mobile-to-mobile calling plan, each consecutive minute of the call is free of additional minute-to-minute charges. Additionally, because the call utilizing the voice over internet protocol is based on a monthly fixed fee, each additional minute is also free from minute-to-minute charges. As a result, the communication system allows the user to make calls from the primary mobile device to any destination number or from any source number without incurring any charges above the set monthly rates of the mobile calling plan and for the voice over internet protocol access.

According to one embodiment of the present invention, a mobile interface is provided for connection to the secondary cell phone. The mobile interface is also connected with the voice over internet access device. The mobile interface is configured to relay signals from the secondary cell phone to the voice over internet access device allowing the user to make calls from the primary cell phone through the voice over internet protocol without requiring additional specialized equipment. According to another embodiment of the present invention, a unified circuitry module is provided which incorporates both the secondary mobile device and a voice over IP access device interface. The unified circuitry module can receive calls directly from the primary mobile device and provide connection with the voice over internet access device without requiring additional specialized circuitry. The unified circuitry module allows a simple and effective mechanism for allowing a user to make such calls.

According to another embodiment of the present invention, an integrated access device module is provided. The integrated access device module includes a secondary mobile device, a mobile to internet access device interface, and an internet access device. The integrated access module is operably connected with a modem. As a result, a user can make calls from the primary cell phone to the integrated access device module and provide the desired connectivity with minimal cost and/or effort.

According to one embodiment of the present invention a method of making and receiving calls with the primary module device utilizing a voice over internet protocol is provided. In the method, a destination number is input on a primary mobile device to make electronic communication with the destination number. The number is then transmitted from the primary mobile device to a secondary mobile device. The secondary mobile device is then linked with a voice over internet protocol. Once the secondary mobile device is linked with the voice over internet protocol, a destination number is transmitted to the voice over internet protocol. The voice over internet protocol is then utilized to connect with the destination number. Once the voice over internet protocol has linked with the destination number signals are transmitted between the destination number and the primary mobile device through the voice over internet protocol and the secondary mobile device.

These and other objects and features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 is a block diagram illustrating a communication system having a mobile-to-mobile calling plan and voice over internet protocol.

FIG. 2 is a flow diagram illustrating a method of making and receiving calls utilizing a primary mobile device.

FIG. 3 is a communication system and apparatus for making and receiving calls utilizing a primary mobile device.

FIG. 4 illustrates a system and apparatus utilizing a unified circuitry module for making calls from a primary mobile device utilizing a voice over internet protocol according to another embodiment of the present invention.

FIG. 5 illustrates a communication system and apparatus for making calls from a primary cell phone utilizing an integrated access device module according to one embodiment of the present invention.

FIG. 6 is a flow diagram illustrating a method of making a call from a primary cell phone utilizing a voice over internet protocol according to one embodiment of the present invention.

FIG. 7 is a perspective view of a mobile interface for use in providing connectivity between a primary mobile device and a voice over internet protocol according to one embodiment of the present invention.

FIG. 8 is a perspective view of a mobile interface for use in providing connectivity between a primary mobile device and a regular land line phone and for making calls over an internet access device.

### DETAILED DESCRIPTION OF THE PREFERRED EMBODIMENTS

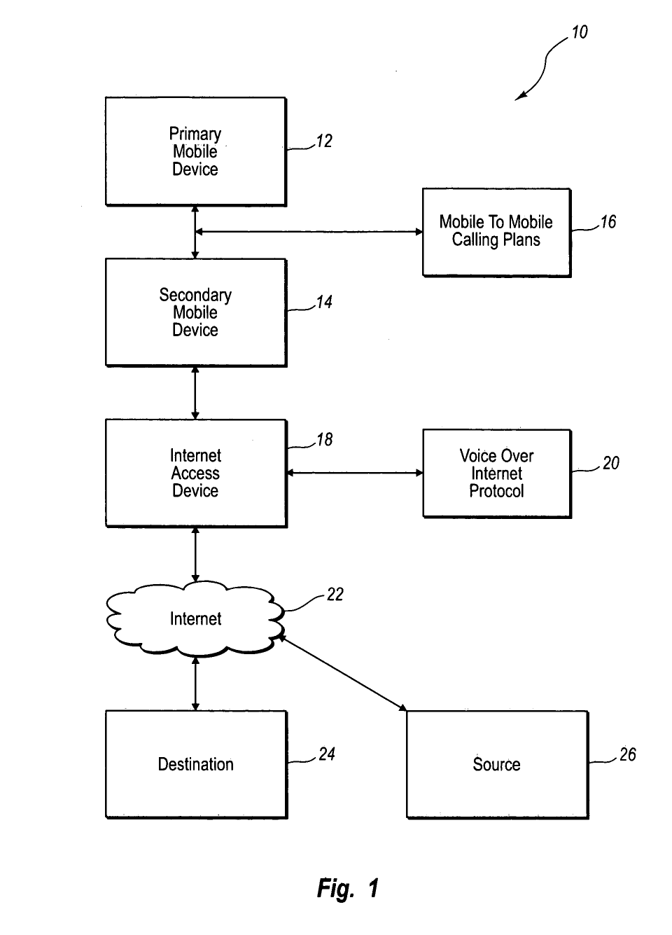

FIG. 1 is a block diagram of a communication system configured to allow a user to make and receive calls at a mobile calling device utilizing a voice over internet protocol according to one embodiment of the present invention. Communication system 10 includes a primary mobile device 12 which is operably connected to a secondary mobile device 14 utilizing a mobile-to-mobile calling plan 16. Calls between primary mobile device 12 and secondary mobile device 14 can be transmitted free of per minute rate charges due to the mobile-to-mobile calling plan 16. Typically, such mobile-to-mobile calling plans 16 are provided as part of the mobile calling plan or for a small fixed additional per month charge.

In the illustrated embodiment, the primary mobile device 12 is carried by the user and utilized to make calls from a variety of locations as the user may select. The secondary mobile device 14 is operably connected to an internet access device 18. Because the greatest cost savings and the most effective manner for providing internet access is through a typical land line, internet access device 18 is typically located in the user's home, business, or other convenient location. Internet access can be coupled through a dialup connection, high speed DSL, dedicated broadband cable line, wireless protocol, or other known internet connection system.

Internet access device module 18 is enabled through the use of a voice over internet protocol module 20. Voice over internet protocol module 20 allows calls to be made through internet access device while bypassing traditional long distance carriers. As a result, calls through the voice over internet protocol can connect with long distance or international numbers without incurring per minute charges in addition to the standard monthly connectivity charge for the voice over internet protocol. Internet access device module 18 provides connection to internet 22 or other known networking system which allows calls to be made utilizing a voice over internet protocol module 20.

The use of internet access device module 18 and voice over internet protocol module 20 allow connection with a destination 24 or a source 26 through Internet 22. When a user desires to make a call from primary mobile device 12, the user inputs the number of secondary mobile device 14. Connection is made between primary mobile device 12 and secondary mobile device 14. Because primary mobile device 12 is connected to secondary mobile device 14 utilizing mobile-to-mobile calling plan 16, per minute charges for the call in addition to the monthly connection charge for the mobile-to-mobile calling plan 16 are not incurred.

Once connection is provided between primary mobile device 12 and secondary mobile device 14 an indicator that connection has been made is provided such as a secondary dial tone. When the user hears the secondary indicator, such as the secondary dial tone, the user inputs the number of destination 24. As will be appreciated by those skilled in the art, destination 24 represents not a single destination number but any of the desired destination numbers including long distance and international numbers. Once the secondary number is input, the number is transmitted through internet access device module 18 utilizing voice over internet protocol module 20. The number is then relayed through the internet 22 and connection is provided with destination 24.

Once connection is provided with destination 24, signals providing such telephonic or other communication are then relayed between primary mobile device 12 and destination 24 utilizing secondary mobile device 14, internet access device module 18, and Internet 22. As previously discussed, because the calls are made utilizing mobile-to-mobile calling plan 16 and voice over internet protocol module 20, additional per minute charges in addition to the monthly access charges are avoided.

Calls from a source 26 can also be relayed to primary mobile device 12 utilizing communication system 10. In the illustrated embodiment, calls from source 26 are relayed through Internet 22 to internet access device module 18 utilizing voice over internet protocol module 20. Connection is then provided between source 26 and secondary mobile device 14. Secondary mobile device 14 then automatically relays the call to primary mobile device 12. Because calls between source 26 and primary mobile device 12 are made utilizing voice over internet protocol module 20 and mobile-to-mobile calling plan 16, calls from source 26 to primary mobile device 12 are free of per minute charges in addition to the monthly access charges for voice over internet protocol module 20 and mobile-to-mobile calling plan 16.

As will be appreciated by those skilled in the art, a variety of types and configurations of communication systems can be utilized without departing from the scope and spirit of the present invention. In one embodiment of the present invention the primary mobile device and the secondary mobile device are connected without utilizing the mobile-to-mobile calling plan or other discount rate package. In another embodiment, the voice over internet protocol is provided at a point other than the internet access device. In another embodiment, the communication system is configured to provide the ability to make solely outgoing calls to a destination number. In another embodiment, the communication system is configured to only receive calls from a source number.

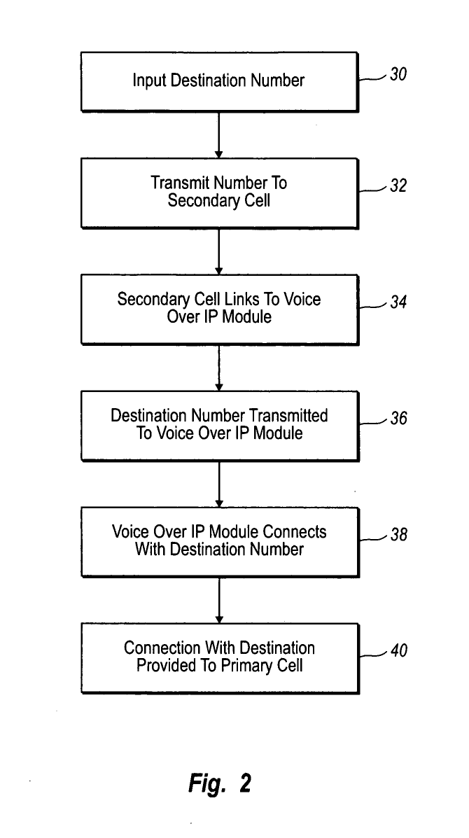

FIG. 2 is a flow diagram illustrating a method of making and receiving calls using a primary mobile device and a voice over internet protocol according to one embodiment of the present invention. In the illustrated embodiment, a destination number is input to a primary mobile device in step 30. Once the destination number is input into the primary mobile device, the number is transmitted to secondary mobile device in step 32. The secondary mobile device is linked to a voice over internet protocol module in step 34. Once the secondary mobile device is linked to the voice over internet module a destination number is transmitted to the voice over internet module in step 36. The voice over internet module connects with the destination number in step 38. Once the voice over internet module connects with the destination number, connection is provided between the destination number and the primary mobile device in step 40.

As will be appreciated by those skilled in the art, a variety of steps and methods of making and receiving calls between the primary mobile device and destination number can be utilized without departing from the scope and spirit of the present invention. For example, in one embodiment, connection is automatically provided between the primary mobile device and the secondary mobile device. When a user accesses the primary mobile device connection is automatically provided between the secondary mobile device and the voice over internet protocol module. The user inputs the destination number into the primary mobile device and connection is automatically made between the destination number and the primary mobile device utilizing the voice over internet protocol module and the secondary mobile device.

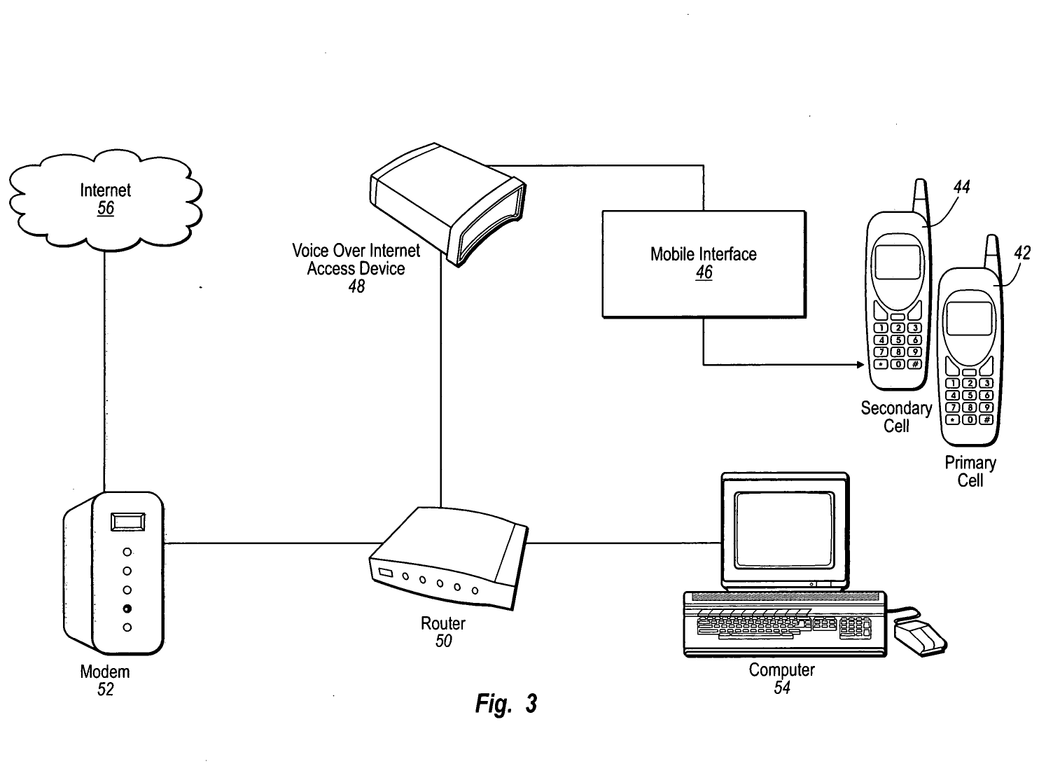

FIG. 3 is a schematic of a communication system and apparatus allowing a user to make and receive calls at mobile calling device utilizing a voice over internet protocol. In the illustrated embodiment, a primary cell phone 42 and a secondary cell phone 44 are provided. As previously discussed, primary cell phone 42 and secondary cell phone 44 will typically be operably connected utilizing a mobile to mobile calling plan which provides preferential discount rate structures such as a small monthly charge for unlimited calling. Secondary cell phone 44 is connected to mobile interface 46. Mobile interface 46 provides connection between secondary cell phone 44 and a voice over internet access device 48. Voice over internet access device 48 is illustrative of voice over internet access devices that can be commercially available and provided by voice over internet protocol companies. Typically such voice over internet access devices allow users to make calls directly without having to log onto a computer, start software or otherwise access the Internet to communicate through the voice over internet protocol. In other words, voice over internet access device 48 provides a dial tone and automatic connectivity to the voice over internet protocol without requiring additional user implementation.

When the voice over internet access device 48 is actuated, router 50 routes signals from voice over internet access device 48 to modem 52. From modem 52 the signals are then conveyed directly to internet 56. In one embodiment, when a user desires to make a call to a destination number, the user first calls the secondary cell phone 44. When the user calls the secondary cell phone 44 the mobile interface 46 relays a signal to the voice over internet access device indicating that the secondary cell phone 44 has been actuated. The voice over internet access device 48 then provides a dial tone indicating that internet 56 has been accessed through modem 52 and router 50. The dial tone is then routed through mobile interface 46 back to secondary cell phone 44.

Once the user hears the dial tone of the voice over internet access device 48 on primary cell phone 42 by means of secondary cell phone 44 and mobile interface 46, the user inputs the desired destination number. The desired destination number is then automatically relayed through the secondary cell phone 44, to mobile interface 46, and then to the voice over internet access device 48. From the voice over internet access device 48 the call is relayed through router 50, modem 52, to Internet 56 and the destination number is contacted using the voice over internet protocol. In this manner, a user can make a call from primary cell phone 42 utilizing a voice over internet protocol and mobile-to-mobile calling plan to avoid additional per minute charges in addition to the monthly connection charges for the mobile-to-mobile calling plan and voice over internet protocol.

As will be appreciated by those skilled in the art, calls can also be received from a source number at primary cell phone 42 utilizing mobile interface 46, voice over internet access device 48, router 50, modem 52, and Internet 56. In the embodiment, a call is received at Internet 56 in connection with the voice over internet protocol. Voice over internet access devices configured to be automatically actuated when a call is received at the voice over internet protocol. Voice over internet access device automatically receives the call from modem 52 through router 50. The call is then relayed from the voice over internet access device through the mobile interface 46, to secondary cell phone 44, and then to the primary cell phone 42. In this manner, the user can receive incoming calls at primary cell phone 42. In the illustrated embodiment, a computer 54 is also shown connected to a router 50. This illustrates that the computer 54 can utilize the same router 50 and modem 52 as voice over internet access device 48.

As will be appreciated by those skilled in the art, a variety of types and configurations of communication system and apparatus can be provided without departing from the scope and spirit of the present invention. For example, in one embodiment, the mobile interface provides additional functionality other than a simple relay to the voice over internet access device. For example, in one embodiment when the primary cell contacts the secondary cell phone the mobile interface first gives a variety of selections from which a user can select rather than only providing a simple dial tone. For example, mobile interface can request that the user select between making voice over internet protocol, telephonic communication, facsimile transmission, an email transmission, or simple access HTML or other pages on the internet directly.

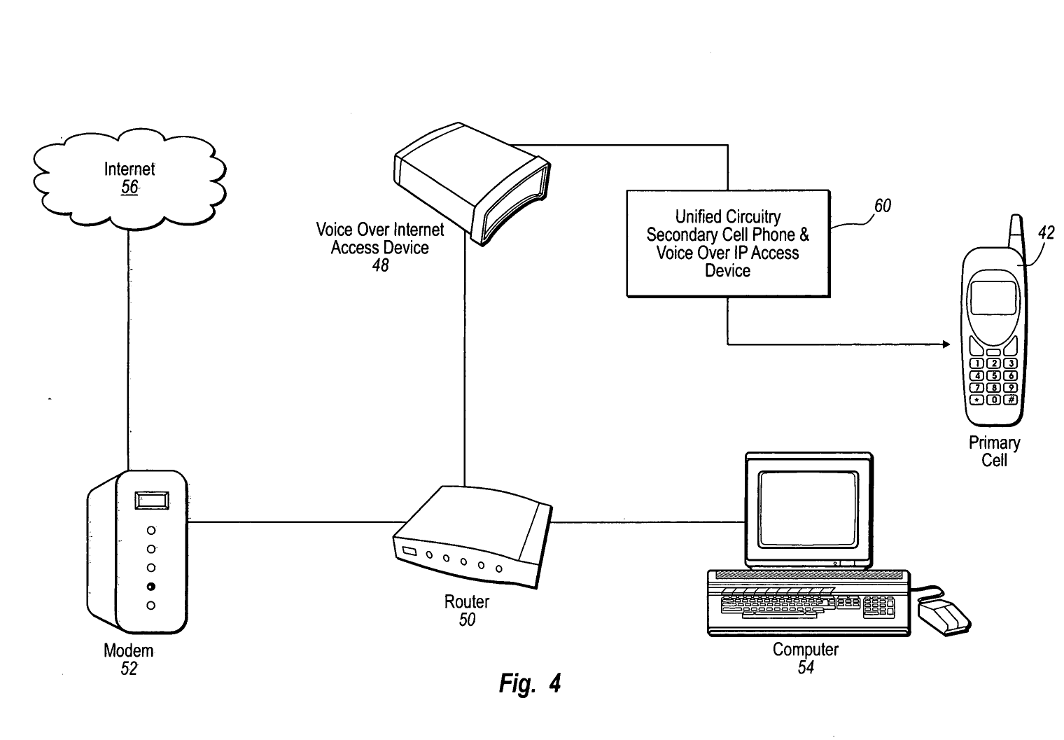

FIG. 4 is a systematic view of the communication system and apparatus according to one embodiment of the present invention. In the illustrated embodiment, a primary cell phone 42 is connected to a voice over internet access device utilizing a unified circuitry module 60. Unified circuitry module 60 includes an integrated secondary cell phone and a voice over internet protocol access device interface. As a result, a user does not have to separately connect a secondary cell phone and to a voice over internet access protocol device interface. Instead, the unified circuitry module 60 provides a simple and effective module for connecting to the voice over internet access device 48.

When the user desires to make a telephonic communication using primary cell phone 42, the user simply inputs the number associated with the unified circuitry module 60. The integrated secondary cell phone provides connection with primary cell phone 42. Once connection is provided with primary cell phone 42, the voice over internet protocol access device interface component of Unified circuit module 60 then automatically connects with voice over internet access device 48. Voice over internet access device then provides a dial tone allowing the user to make a call directly from primary cell phone 42 to the destination number utilizing the voice over internet protocol associated with Internet 56.

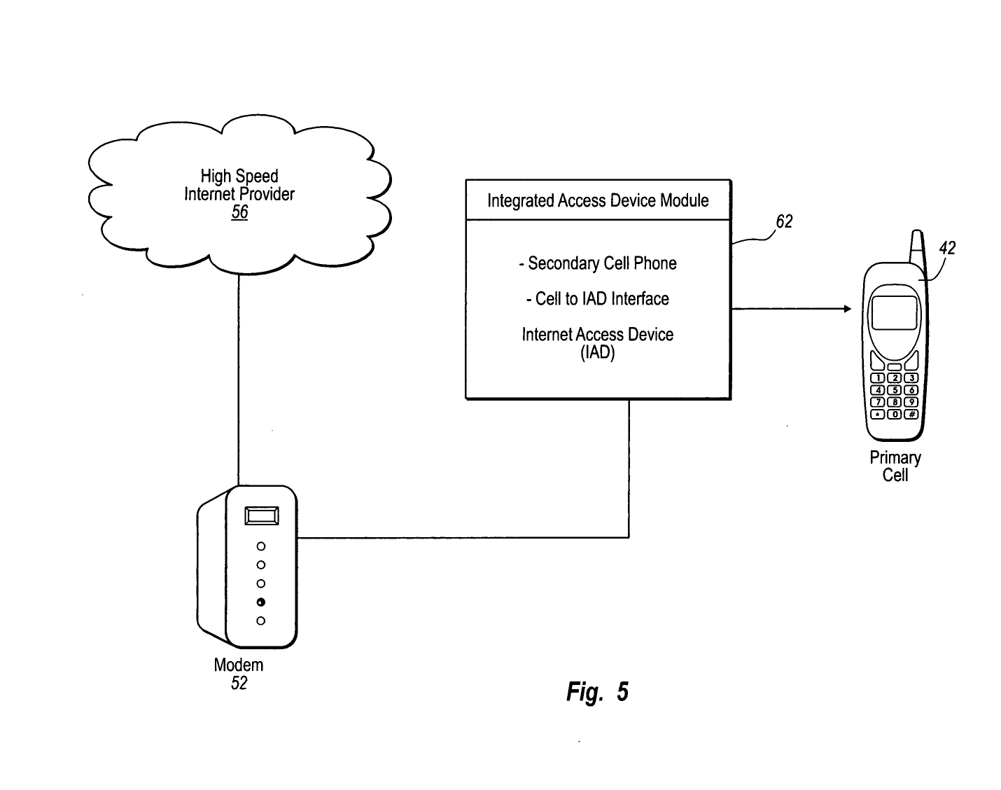

FIG. 5 illustrates a communication system utilizing an integrated access device module 62 according to one embodiment of the present invention. In the illustrated embodiment, integrated access device module 62 includes a secondary cell phone, a cell to internet access device interface, and an internet access device. Integrated access device module 62 provides a single component that can be utilized to allow a user to make calls from primary cell phone 42 through a voice over internet protocol associated with internet 56. In the illustrated embodiment, integrated access device module 62 is connected with a dedicated modem 52 in connection with the high speed internet provider 56. The user makes a call from primary cell phone 42 and is automatically connected to the destination number without requiring multiple components or steps of implementation. As will be appreciated by those skilled in the art, the functionality of the integrated access devices module 62 can include additional functionality such as that provided in connection with the communication systems illustrated in FIGS. 3 and 4.

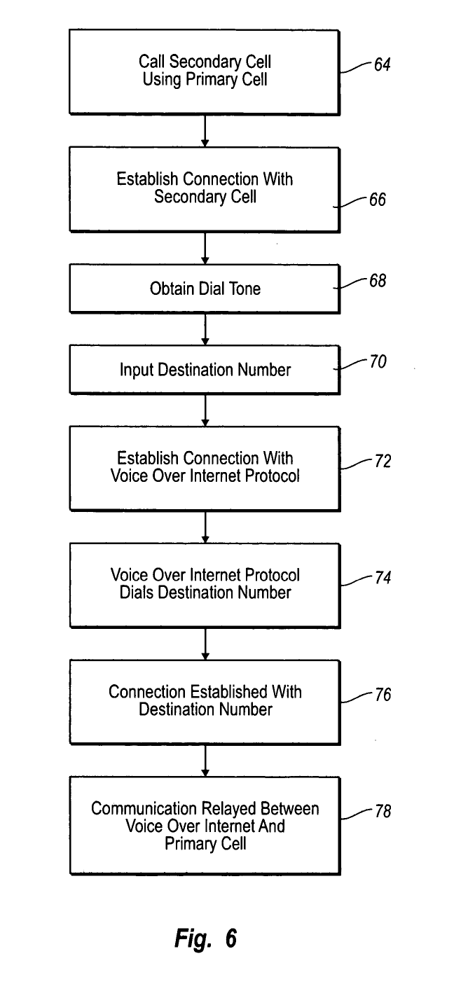

FIG. 6 is a flow diagram illustrating a method of utilizing a mobile-to-Z mobile calling plan and voice over internet protocol allowing a user to make and receive calls utilizing a primary mobile device. In the method, a user calls a secondary cell phone from a primary cell phone in step 64. Connection is established between the primary cell phone and the secondary cell phone in step 66. Once the connection is established between the primary cell phone and the secondary cell phone, a dial tone is obtained in step 68. Once a dial tone is obtained the user inputs a destination number into primary cell phone in step 70. A connection is then established with the voice over internet protocol in step 72. Once connection is established with the voice over internet protocol, the voice over internet protocol dials the destination number in step 74. A connection is established with the destination number utilizing the voice over internet protocol in step 76. Once the connection is established with the destination number, communication is relayed between the voice over internet protocol and the primary cell phone in step 78.

As will be appreciated by those skilled in the art, a variety of types and configurations of methods for making a call using mobile-to-mobile and voice over internet protocols can be utilized without departing from the scope and spirit of the present invention. For example, a connection can be established with the voice over internet protocol before a dial tone is provided to the primary cell phone from the secondary cell phone and before the user inputs the destination number. In another embodiment, the primary cell phone and the secondary cell phone are not connected utilizing a mobile-to-mobile calling plan.

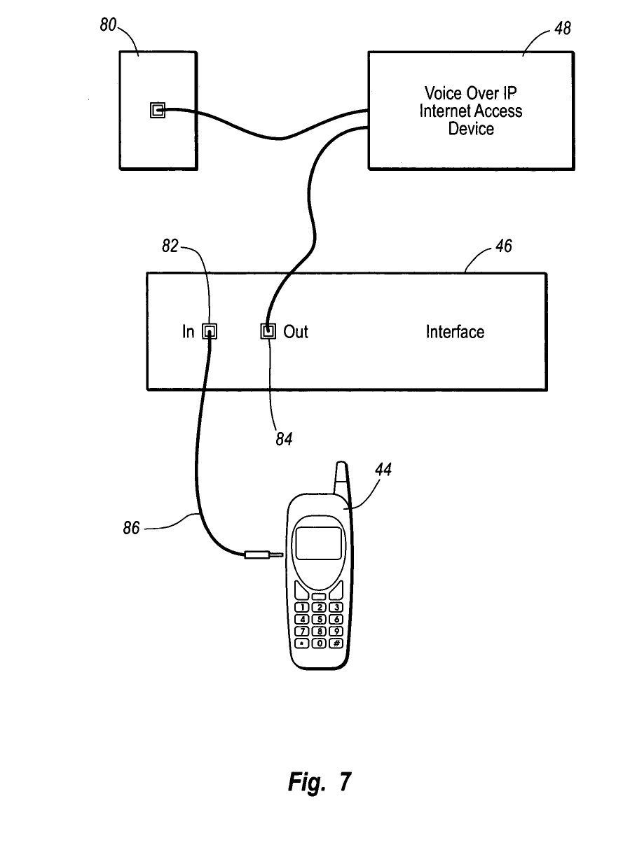

FIG. 7 illustrates a perspective view of a mobile interface providing connection between a primary cell phone and voice over internet protocol access device 48. In the illustrated embodiment, mobile interface 46 comprises an inlet port 82 and an outlet port 84. Inlet port 82 is configured to be operably coupled to secondary cell phone 44 utilizing an interconnection line 86. When secondary cell phone 44 is coupled to mobile interface 46 at inlet port 82, information can be transmitted to voice over internet access device 48 from a primary cell phone utilizing secondary cell phone 44 and mobile interface 46. Voice over internet access device 48 is coupled to mobile interface 46 utilizing outlet port 84. Voice over internet access device 48 is coupled to a wall connector 80. In the illustrated embodiment wall connector 80 comprises a coaxial cable jack such as that utilized for a dedicated high speed internet line.

In the illustrated embodiment, the interconnection line is coupled to secondary cell phone 44 at an outlet port of secondary cell phone 44. Examples of outlet ports can include a headphone jack or similar outlet port. When a primary cell phone is utilized to call secondary cell phone 44, ringing of secondary cell phone is detected by mobile interface 46. When interface 46 detects ringing of secondary cell phone 44, a signal is transmitted to secondary cell phone answering the call received from primary cell. Once a connection is provided between the primary cell phone and secondary cell phone 44, voice over internet protocol is signaled that the user is attempting to place a call using the communication system.

Voice over internet access device 48 automatically connects to the Internet in connection with a voice over internet protocol. Once a connection is established with the voice over internet protocol, a dial tone is provided from the voice over internet access device 48 through mobile interface 46 and secondary cell phone 44. When the user detects the secondary dial tone at primary mobile device, the user inputs the desired destination number. The dial tone from the dialing of the destination number at the primary mobile device is transmitted through the secondary cell phone 44 and relayed from mobile interface 46 to voice over internet access device 48. Voice over internet access device 48 then contacts the destination phone number through voice over internet protocol. In one embodiment, voice over internet access device 48 includes an integrated modem and/or other equipment enabling voice over internet access device 48 to connect to the Internet through a dial-up or broadband connection.

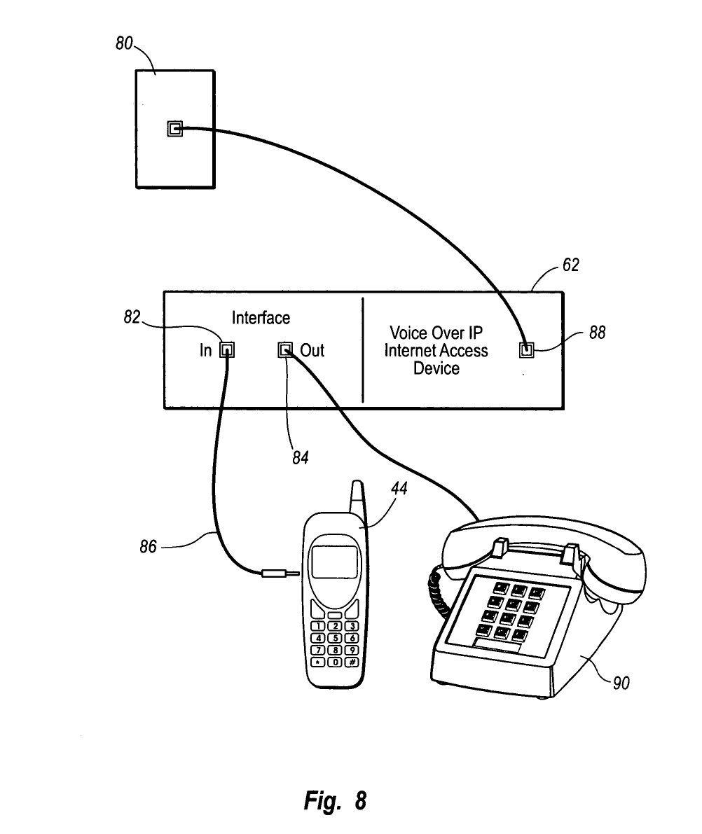

FIG. 8 is a perspective view of an integrated access device module 62 according to one embodiment of the present invention. In the illustrated embodiment, integrated access device module includes a mobile interface and a voice over internet access device integrated into a single unit. The interface of integrated access device module 62 includes an inlet port 82 and a telephone input port 88. Inlet port 82 provides connection with secondary cell phone 44 by means of an interconnection line 86. Telephone inlet port 88 provides connection with a telephone 90. In the illustrated embodiment, telephone 90 comprises a conventional telephone such as that utilized in land line connections. By providing a telephone input port 88 for connection with telephone 90.

When is user is at home, work, or other location in which integrated access device module 62 is utilized, the user can simply make voice over internet calls directly from telephone 90 rather than using mobile-to-mobile communication from the primary cell phone. The voice over internet access device portion of integrated access device module 62 includes an outlet port 84a for communicating with the Internet to provide voice over internet protocol communication. Voice over internet access device portion of integrated access device module 62 can operate in either the context in which the call comes from secondary cell phone 44 through inlet port 82 or from telephone 90 through telephone input port 88.

As will be appreciated by those skilled in the art, inlet port 82 of FIG. 7, outlet port 84 of FIG. 7, inlet port 82 of FIG. 8, inlet port 88 of FIG. 8, and outlet port 84a of FIG. 8, will typically comprise input/output functionality and are not restricted to input and output. The terminology inlet and outlet are provided for simplicity in describing the components of the mobile interface, voice over internet access device, and/or integrated access device module and are not to be construed as limiting in nature.

As will be appreciated by those skilled in the art, a variety of types and configurations of mobile interfaces and/or integrated access device modules can be utilized without departing from scope and spirit of the present invention. For example, an RF or other wireless signal can be provided for communication between the secondary cell phone and the mobile interface. In another embodiment, an RF or another signal is provided for communication between the voice over internet access device and the internet source.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A communication system allowing a user to make and receive calls at a mobile calling device utilizing a voice over internet protocol, the communication system comprising:
a primary mobile device for use in making telephonic or other communication;
a secondary mobile device operatively connected to the primary mobile device allowing the user to make calls from the primary mobile device to the secondary mobile device; and
an internet access device operatively connected to the secondary mobile device and providing access to a voice over internet protocol and being configured to allow a user to make calls from the primary mobile device to a destination number over the internet protocol through the secondary mobile device.

2. The communication system of claim 1, wherein the internet access device is configured allow the user to receive calls at the primary mobile device from a source number using the voice over internet protocol through the secondary mobile device.

3. The communication system of claim 1, wherein the secondary mobile device is connected to the internet access device utilizing an interconnection line.

4. The communication system of claim 1, wherein the secondary mobile device is connected to the internet access device utilizing a wireless signal.

5. The communication system of claim 1, wherein the secondary mobile device is integrally coupled to the internet access device.

6. The communication system of claim 1, further comprising a voice over internet access device configured to provide connection between the internet access device and the voice over internet protocol.

7. The communication system of claim 6, wherein the secondary mobile device, the internet access device, and the voice over internet access device are integrally coupled together comprising an integrated access device module.

8. A mobile to mobile and voice over internet protocol apparatus allowing a user to make and receive calls using a primary mobile calling device utilizing a voice over internet protocol, the mobile to mobile and voice over internet protocol apparatus comprising:
a voice over internet access device providing access to a network and allowing for transmission of telephone calls or other electronic communication using a voice over internet protocol;
mobile interface operably connected to the voice over internet access device and being adapted to receive telephone calls or other electronic communication and transmit the signals to the voice over internet access device;
a connection mechanism providing connection between the mobile interface and a secondary mobile device which is operatively connected to the primary mobile device, the connection mechanism configured to transmit signals to the mobile interface from the primary mobile device through the secondary mobile device such that the user can make calls from the primary mobile device to a destination number and receive calls at the primary mobile device from a source number using the voice over internet protocol through the secondary mobile device.

9. The mobile to mobile and voice over internet protocol apparatus of claim 8, wherein the network to which the voice over internet access device provides access comprises the Internet.

10. The mobile to mobile and voice over internet protocol apparatus of claim 8, wherein the voice over internet access device comprises a personal computer.

11. The mobile to mobile and voice over internet protocol apparatus of claim 8, wherein the voice over internet access device comprises a commercially available device.

12. The mobile to mobile and voice over internet protocol apparatus of claim 8, wherein the mobile interface is integrated into the secondary mobile device.

13. The mobile to mobile and voice over internet protocol apparatus of claim 8, wherein the mobile interface is integrated into the voice over internet access device.

14. The mobile to mobile and voice over internet protocol apparatus of claim 8, wherein the connection mechanism comprises an interconnection line.

15. The mobile to mobile and voice over internet protocol apparatus of claim 8, wherein the connection mechanism comprises a wireless interface.

16. The mobile to mobile and voice over internet protocol apparatus of claim 8, wherein the connection mechanism comprises an RF interface.

17. A method of making and receive calls using a primary mobile calling device utilizing a voice over internet protocol, the mobile to mobile and voice over internet protocol apparatus comprising:
inputting a destination number on a primary mobile device to make electronic communication with the destination number;
transmitting the number from the primary mobile device to a secondary mobile device;
linking the secondary mobile device with a voice over internet protocol;
transmitting the destination number to the voice over internet protocol;
connecting with the destination number utilizing the voice over internet protocol;
transmitting signals between the destination number and the primary mobile device through the voice over internet protocol and the secondary mobile device.

18. The method of claim 17, wherein the step of transmitting the number from the primary mobile device to the secondary mobile device is conducted automatically.

19. The method of claim 17, wherein the step of linking the secondary mobile device with the voice over internet protocol is conducted automatically.

20. The method of claim 17, wherein the step of transmitting the destination number to the voice over internet protocol is conducted automatically.

21. The method of claim 17, wherein the step of connecting with the destination number utilizing the voice over internet protocol is conducted automatically.

22. The method of claim 17, wherein the step of transmitting the signals between the destination number and the primary mobile device through the voice over internet protocol and the secondary mobile device is conducted automatically.

23. The method of claim 17, wherein the step of linking the secondary mobile device with a voice over internet protocol is conducted using a mobile interface.

24. The method of claim 17, wherein the step of linking the secondary mobile device with a voice over internet protocol is conducted using a voice over internet access device.
